(19) United States
(12) Patent Application Publication
(10) Pub. No.: US 2024/0161130 A1
(43) Pub. Date: May 16, 2024

(54) DETERMINING A NEW CANDIDATE FEATURE FOR A PREDETERMINED PRODUCT BASED ON AN IMPLICIT REQUEST OF A USER

(71) Applicant: Kyndryl, Inc., New York, NY (US)

(72) Inventors: Mouleswara Reddy Chintakunta, Allagadda (IN); Omar Odibat, Cedar Park, TX (US); Manish Mitruka, Pune (IN); Anand Bandaru, Bangalore (IN)

(21) Appl. No.: 17/987,595

(22) Filed: Nov. 15, 2022

(51) Int. Cl. G06Q 30/02

(52) U.S. Cl. CPC G06Q 30/0201

(57) ABSTRACT

A computer-implemented method, according to one embodiment, includes collecting user data associated with a user's behavior with respect to a predetermined product and analyzing the user data for determining a subset of the user data that constitutes an implicit request for a new candidate feature for the predetermined product. A new candidate feature for the predetermined product that satisfies the implicit request is determined based on the subset of the user data. The method further includes outputting an indication of the determined new candidate feature to a device associated with development of the predetermined product. A computer program product, according to another embodiment, includes a computer readable storage medium having program instructions embodied therewith. The program instructions are executable by a computer to cause the computer to perform the foregoing method.

### BACKGROUND

The present invention relates to features of a product, and more specifically, this invention relates to determining a new candidate feature for a predetermined product that satisfies an implicit request of a user.

Products are often used by users for a plurality of reasons. For example, a product may include a cloud-based database that is used by a user to store and access a plurality of business records. In another example, a product may include a commercial application that is used by a user to, e.g., list and sell merchandise, order materials for the commercial business, post business announcements, etc.

Products often include at least some features. A product feature is a function and/or service that is typically added to a product based on a user's, e.g., customer of the product, requirements. The features are resources available to such users during the course of the user utilizing the product. For example, a cloud management feature (more specifically an action) of a web-based service product may include turning on and/or off a virtual machine (VM) of the product. In another example, a cloud management feature (more specifically an action) of a web-based service product may include actions such as deleting specified data that is stored on a database used by the product. In yet another example, a cloud management feature (more specifically an action) of a cloud computing service product may include actions such as resizing data that is stored on a database used by the product.

### SUMMARY

A computer-implemented method, according to one embodiment, includes collecting user data associated with a user's behavior with respect to a predetermined product and analyzing the user data for determining a subset of the user data that constitutes an implicit request for a new candidate feature for the predetermined product. A new candidate feature for the predetermined product that satisfies the implicit request is determined based on the subset of the user data. The method further includes outputting an indication of the determined new candidate feature to a device associated with development of the predetermined product.

A computer program product, according to another embodiment, includes a computer readable storage medium having program instructions embodied therewith. The program instructions are executable by a computer to cause the computer to perform the foregoing method.

A system according to another embodiment includes a hardware processor, and logic integrated with the processor, executable by the processor, or integrated with and executable by the processor. The logic is configured to collect user data associated with a user's behavior with respect to a predetermined product. The logic is further configured to determine a new candidate feature for the predetermined product that satisfies an implicit request for a new candidate feature for the predetermined product. The implicit request is based on a subset of the user data. An indication of the determined new candidate feature is output to a device associated with development of the predetermined product.

Other aspects and embodiments of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a network architecture, in accordance with one embodiment of the present invention.

FIG. 2 is a diagram of a representative hardware environment that may be associated with the servers and/or clients of FIG. 1, in accordance with one embodiment of the present invention.

FIG. 3 is a flowchart of a method, in accordance with one embodiment of the present invention.

FIG. 4 is a flowchart of a method, in accordance with one embodiment of the present invention.

FIG. 5 depicts a comparison, in accordance with one embodiment of the present invention.

FIGS. 6A-6F depict representations for determining and implementing a new candidate feature for a predetermined product based on an implicit request, in accordance with several embodiments of the present invention.

FIG. 7A is a flowchart of a method, in accordance with one embodiment of the present invention.

FIG. 7B is a flowchart of sub-operations of an operation of the flowchart of FIG. 7A, in accordance with one embodiment of the present invention.

FIG. 8 is a flowchart of a method, in accordance with one embodiment of the present invention.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred embodiments of systems, methods and computer program products for determining a new candidate feature for a predetermined product that satisfies an implicit request of a user.

In one general embodiment, a computer-implemented method includes collecting user data associated with a user's behavior with respect to a predetermined product and analyzing the user data for determining a subset of the user data that constitutes an implicit request for a new candidate feature for the predetermined product. A new candidate feature for the predetermined product that satisfies the implicit request is determined based on the subset of the user data. The method further includes outputting an indication of the determined new candidate feature to a device associated with development of the predetermined product.

In another general embodiment, a computer program product includes a computer readable storage medium having program instructions embodied therewith. The program instructions are executable by a computer to cause the computer to perform the foregoing method.

In another general embodiment, a system includes a hardware processor, and logic integrated with the processor, executable by the processor, or integrated with and executable by the processor. The logic is configured to collect user data associated with a user's behavior with respect to a predetermined product. The logic is further configured to determine a new candidate feature for the predetermined product that satisfies an implicit request for a new candidate feature for the predetermined product. The implicit request is based on a subset of the user data. An indication of the determined new candidate feature is output to a device associated with development of the predetermined product.

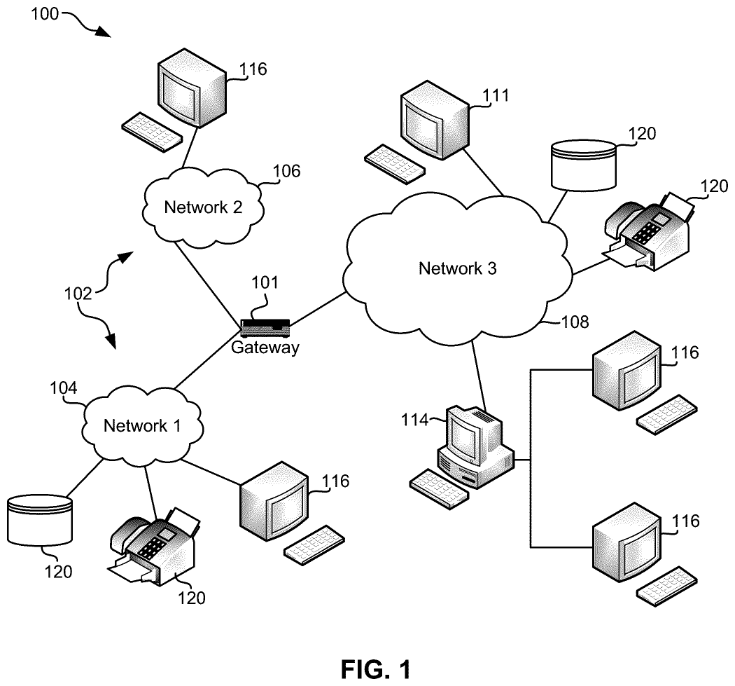

FIG. 1 illustrates an architecture 100, in accordance with one embodiment. As shown in FIG. 1, a plurality of remote networks 102 are provided including a first remote network 104 and a second remote network 106. A gateway 101 may be coupled between the remote networks 102 and a proximate network 108. In the context of the present architecture 100, the networks 104, 106 may each take any form including, but not limited to a local area network (LAN), a wide area network (WAN) such as the Internet, public switched telephone network (PSTN), internal telephone network, etc.

In use, the gateway 101 serves as an entrance point from the remote networks 102 to the proximate network 108. As such, the gateway 101 may function as a router, which is capable of directing a given packet of data that arrives at the gateway 101, and a switch, which furnishes the actual path in and out of the gateway 101 for a given packet.

Further included is at least one data server 114 coupled to the proximate network 108, and which is accessible from the remote networks 102 via the gateway 101. It should be noted that the data server(s) 114 may include any type of computing device/groupware. Coupled to each data server 114 is a plurality of user devices 116. User devices 116 may also be connected directly through one of the networks 104, 106, 108. Such user devices 116 may include a desktop computer, lap-top computer, hand-held computer, printer or any other type of logic. It should be noted that a user device 111 may also be directly coupled to any of the networks, in one embodiment.

A peripheral 120 or series of peripherals 120, e.g., facsimile machines, printers, networked and/or local storage units or systems, etc., may be coupled to one or more of the networks 104, 106, 108. It should be noted that databases and/or additional components may be utilized with, or integrated into, any type of network element coupled to the networks 104, 106, 108. In the context of the present description, a network element may refer to any component of a network.

According to some approaches, methods and systems described herein may be implemented with and/or on virtual systems and/or systems which emulate one or more other systems, such as a UNIX® system which emulates an IBM® z/OS® environment (IBM and all IBM-based trademarks and logos are trademarks or registered trademarks of International Business Machines Corporation and/or its affiliates), a UNIX® system which virtually hosts a known operating system environment, an operating system which emulates an IBM® z/OS® environment, etc. This virtualization and/or emulation may be enhanced through the use of VMware® software, in some embodiments.

In more approaches, one or more networks 104, 106, 108, may represent a cluster of systems commonly referred to as a “cloud.” In cloud computing, shared resources, such as processing power, peripherals, software, data, servers, etc., are provided to any system in the cloud in an on-demand relationship, thereby allowing access and distribution of services across many computing systems. Cloud computing typically involves an Internet connection between the systems operating in the cloud, but other techniques of connecting the systems may also be used.

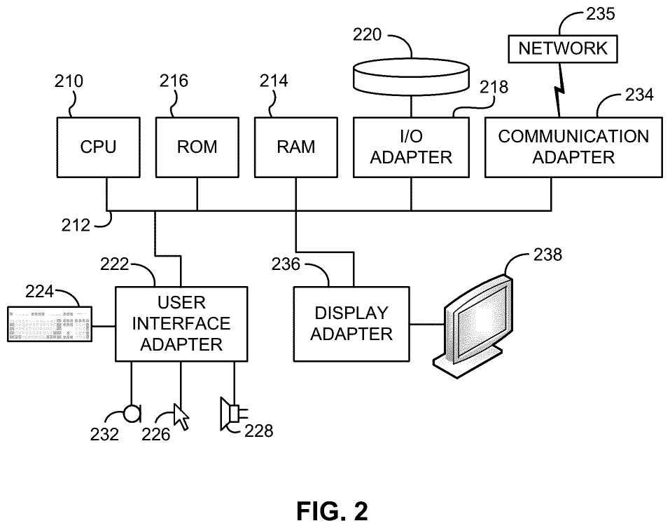

FIG. 2 shows a representative hardware environment associated with a user device 116 and/or server 114 of FIG. 1, in accordance with one embodiment. Such figure illustrates a typical hardware configuration of a workstation having a central processing unit 210, such as a microprocessor, and a number of other units interconnected via a system bus 212.

The workstation shown in FIG. 2 includes a Random Access Memory (RAM) 214, Read Only Memory (ROM) 216, an input/output (I/O) adapter 218 for connecting peripheral devices such as disk storage units 220 to the bus 212, a user interface adapter 222 for connecting a keyboard 224, a mouse 226, a speaker 228, a microphone 232, and/or other user interface devices such as a touch screen and a digital camera (not shown) to the bus 212, communication adapter 234 for connecting the workstation to a communication network 235 (e.g., a data processing network) and a display adapter 236 for connecting the bus 212 to a display device 238.

The workstation may have resident thereon an operating system such as the Microsoft Windows® Operating System (OS), a macOS®, a UNIX® OS, etc. It will be appreciated that a preferred embodiment may also be implemented on platforms and operating systems other than those mentioned. A preferred embodiment may be written using eXtensible Markup Language (XML), C, and/or C++ language, or other programming languages, along with an object oriented programming methodology. Object oriented programming (OOP), which has become increasingly used to develop complex applications, may be used.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Moreover, a system according to various embodiments may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

As mentioned elsewhere above, products are often used by users for a plurality of reasons. For example, a product may include a cloud-based database that is used by a user to store and access a plurality of business records. In another example, a product may include a commercial application that is used by a user to, e.g., list and sell merchandise, order materials for the commercial business, post business announcements, etc.

Products often include at least some features. A product feature is a function and/or service that is typically added to a product based on a user's, e.g., customer of the product, requirements. The features are resources available to such users during the course of the user utilizing the product. For example, a cloud management feature (more specifically an action) of a web-based service product may include turning on and/or off a virtual machine (VM) of the product. In another example, a cloud management feature (more specifically an action) of a web-based service product may include actions such as deleting specified data that is stored on a database used by the product. In yet another example, a cloud management feature (more specifically an action) of a cloud computing service product may include actions such as resizing data that is stored on a database used by the product.

In some deployments of a product, the need for a new feature arises, e.g., such as a feature that includes a scheduler or a buy plan. This new feature may be added to an existing set of features and/or actions, however, conventional techniques for adding a new feature to a product are prone to issues. For example, it is often difficult for product managers to determine what features a customer has a need for until the customer explicitly describes in detail to the product manager, various gaps and/or requirements that the customer has experienced while using the product. Only after such an explicit discussion is conducted can a team of product managers begin developing a new feature to span such gaps and/or fulfill the requirements needed by the customer. For example, a product manager may receive several requirements from several users and prioritize them in a roadmap. The product manager may need to manually reroute the requirements to an associated roadmap when users incorrectly assign feature requests. This is a relatively time consuming process, and resource intensive process, as product managers often spend a relatively extensive amount of time working with the customer to identify the gaps and/or requirements before even beginning to develop a new feature. This sometimes results in missed opportunities to offer features on a product that promote efficient use of the product, as product manager resources are spread thin during the process of finding new features for a given customer. This is unacceptable to customers. For at least these reasons, conventional techniques also fail to identify new features that a customer could benefit from a product having, unless such features are specifically described by the customer to the product manager.

In sharp contrast to the various deficiencies of the conventional techniques described above, the techniques of various embodiments and approaches described herein include using machine learning type of analysis of user data, e.g., user data and infrastructure, to determine at least some new candidate features for implementing in a predetermined product, where the new candidate feature(s) satisfy an implicit request of a user. More specifically, the request may be implied by text-based user data and/or user behavior associated with the user using the predetermined product. The user data and/or behavior is analyzed using a passive pattern matching component, e.g., a predetermined pattern detection algorithm, used to generate new candidate features from passive cost and asset data. Additionally, an NLP processor system augments user profile identification in addition to user behavior and learns potential candidate features from user communication, user cost data, user asset config, compliance, etc. Furthermore, a novel candidate feature extraction algorithm identifies a common pattern across multiple graphs. Various of the machine learning techniques learn from the user's behavior while using the predetermined product, and then predict candidate product features which are mapped to a development team. In addition to user behavior, the proposed techniques learn from cost, asset config, compliance and other user communications through a dedicated NLP component in order to predict such candidate product features. Various benefits are enabled as a result of using these novel techniques. For example, a relatively faster, scalable and automated feature generation process is enabled. Customer retention and adoption is also enabled because features useful to a user are populated into a product without users even having to be involved in the detection and development process of adding a new feature to a product.

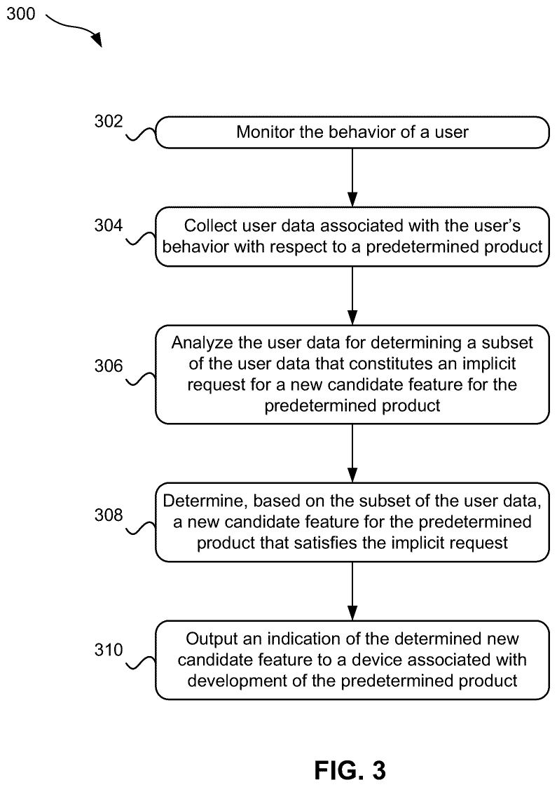

Now referring to FIG. 3, a flowchart of a method 300 is shown according to one embodiment. The method 300 may be performed in accordance with the present invention in any of the environments depicted in FIGS. 1-8, among others, in various embodiments. Of course, more or fewer operations than those specifically described in FIG. 3 may be included in method 300, as would be understood by one of skill in the art upon reading the present descriptions.

Each of the steps of the method 300 may be performed by any suitable component of the operating environment. For example, in various embodiments, the method 300 may be partially or entirely performed by a computer, or some other device having one or more processors therein. The processor, e.g., processing circuit(s), chip(s), and/or module(s) implemented in hardware and/or software, and preferably having at least one hardware component may be utilized in any device to perform one or more steps of the method 300. Illustrative processors include, but are not limited to, a central processing unit (CPU), an application specific integrated circuit (ASIC), a field programmable gate array (FPGA), etc., combinations thereof, or any other suitable computing device known in the art.

Operation 302 includes monitoring the behavior of a user. It should be noted that in some preferred approaches, behavior of the user is monitored only subsequent to gaining permission from the user to monitor the user's behavior, e.g., an opt-in. The user behavior may in some approaches include the user's use of a first device, e.g., a computer, a cell phone, a tablet, a device having a processing circuit integrated therewith, etc., to interact with the predetermined product. The user behavior may additionally and/or alternatively include, e.g., voice commands, tracked eye movement with respect to a display of the first device, web searches, purchase habits, operation of the first device, etc. The predetermined product may depend on the approach. According to various approaches, the product may include a web service, a cloud-based storage platform, a known type of business product, a virtual retail platform, an auditing program, a scheduler, etc. Such interaction may include the first device utilizing features of the predetermined product. For example, such features may include, e.g., a virtual dashboard, a rescheduling option, a time converter, delete functions, resizing functions, powering on a device, powering off a device, etc.

The monitoring may be performed using a known type of application navigation tracking algorithm in some approaches, e.g., cookies. In some other approaches the monitoring may be performed by screen recording the first device during user of the first device and thereafter performing a known type of image analysis on the recording to determine a traversal performed on the first device and how the traversal impacted the predetermined product.

User data associated with the user's behavior with respect to the predetermined product is collected, e.g., see operation 304. The user data may include information that details the user behavior with respect to the interaction with the predetermined product. It should be noted that in some approaches, the monitoring performed in operation 302 is an optional operation. For example, as opposed to monitoring the user's behavior and collecting the user data associated with the user's behavior, in some approaches, the user data associated with the user's behavior with respect to the predetermined product may be collected from an external monitoring service and/or device. In some other approaches, the user data may additionally and/or alternatively be extracted from and thereby collected from user information and thereby include text-based data, e.g., documents, records, bank spending information, cost documents and/or data associated with the user's spending, asset configuration documents, asset data associated with the user's assets where the cost data and/or asset data is collected from an infrastructure associated with the user, the user's reports, the user's messages such as complaint messages, complaint reports, surveys, emails, text messages, chat sessions, notes, etc. In one or more of such approaches, collection of the user data may be performed using known techniques for auditing text, performing text mining on a sample of text, performing keyword search analysis on a collection of documents, etc. In yet some other approaches, the user data may be collected by monitoring the user's behavior with respect to the predetermined product, and recording predetermined user information upon and in response to detecting predetermined events and/or actions taken by the user.

Monitoring of the user behavior and/or collection of the user data may be performed over a predetermined period of time, in some approaches. For example, the monitoring of the user behavior and/or collection of the user data may be performed for a predetermined amount of time beginning at a predetermined time and/or event. In some other approaches, the monitoring of the user behavior and/or collection of the user data may be performed with respect to a plurality of sessions in which the user uses the first device to interact with the predetermined product. The sessions may occur according to, e.g., the predetermined product powering on and/or off, a predetermined period of time, events in which the user and/or the first device interacts with the predetermined product, events in which a predetermined action is performed with respect to the predetermined product, etc.

The user data is analyzed for determining a subset of the user data that constitutes an implicit request, e.g., hidden features and/or patterns that are implicit and not explicitly expressed by the user, for a new candidate feature for the predetermined product, e.g., see operation 306. It should be noted that the term “implicit” may specify that the request is not one that the user expressly makes, e.g., expressly made by a request to a developer. Expressly made requests are otherwise performed in some conventional techniques, but cause inefficiencies and other issues described elsewhere above. In sharp contrast to expressly made requests, by determining the subset of the user data that constitutes an implicit request using the techniques described herein, new product features that a user may not even be aware of having a use for, e.g., an unknown need, while interacting with the predetermined product are realized.

In some approaches, techniques for analyzing the user data may depend on whether the user data is based on user behavior and/or text-based data. For example, various techniques for analyzing the user data based on user behavior may be based on user data collected with respect to a plurality of sessions in which the user interacts with the predetermined product, e.g., via use of the first device. More specifically, each “session” may be a series of actions performed by user, e.g., with respect to the predetermined product. In some approaches in which the user data is based on the plurality of sessions, analyzing the user data for determining the subset of the user data may include performing a predetermined process for at least some, and preferably all of the sessions. The process may include identifying, for each session, events taken by the user during the session. The events may in some approaches include device input actions, e.g., performing a login click, performing a logout click, selecting an asset of an infrastructure, performing a utilization check, viewing a cost summary chart, etc. Such device input actions may be input into the first device which may be configured to interact with the predetermined product and/or have an application associated with the product and/or the predetermined product loaded on the first device. Nodes, each representing a different one of the actions, may be generated in some approaches. Furthermore, the nodes may additionally and/or alternatively be added to graphs that are generated according to the sessions. For example, each graph may represent a different one of the sessions, and the graph may include nodes each associated with a different one of the events taken by the user with respect to the predetermined product within that session.

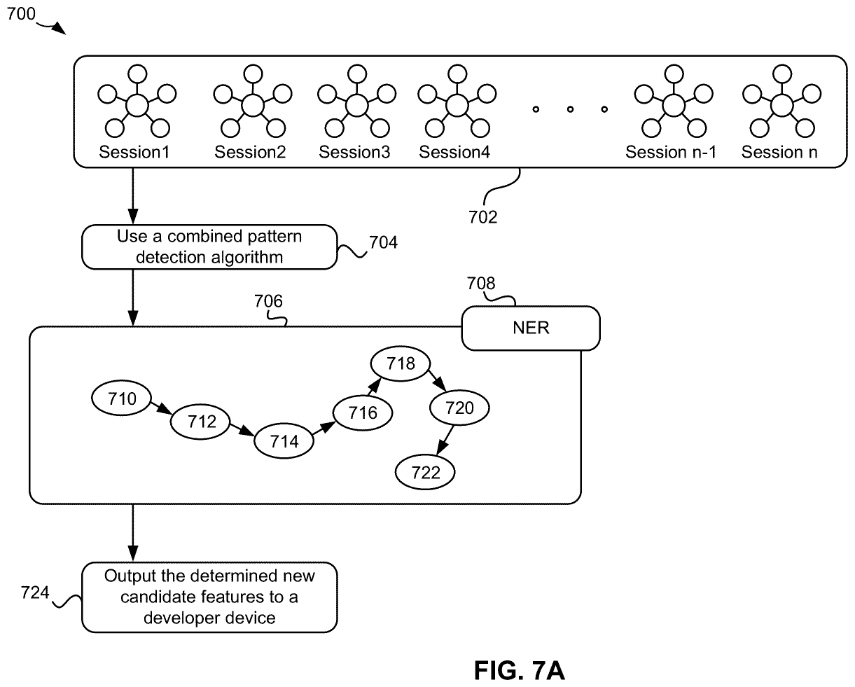

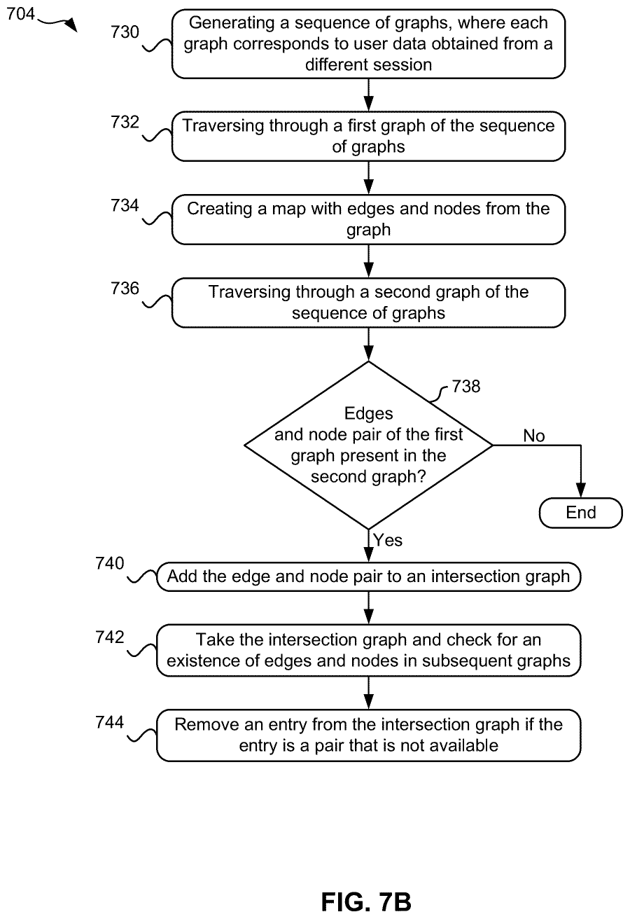

The process of analyzing the user data may additionally and/or alternatively include applying a predetermined pattern detection algorithm, e.g., such as a known type of combined pattern detection algorithm, on the events of the sessions to determine whether a pattern exists in at least some of the events of at least two of the sessions. Note that in some approaches, it may be specified that the pattern must exist in, e.g., each of the sessions, a majority of the session, at least a predetermined number of the sessions, etc., in order for it to be determined that the pattern exists. In some approaches, the predetermined pattern detection algorithm may be applied to a graph that includes nodes each associated with a different one of the events. For example, assuming that graphs with nodes are generated for each of the sessions, each of the graphs may be added as input to the predetermined pattern detection algorithm to determine whether a pattern exists in at least some of the events of at least two of the sessions. Accordingly, an output of the predetermined pattern detection algorithm may include common pattern(s) that exist across at least some of the graphs. Note that illustrative operations, which may be performed in accordance with using the predetermined pattern detection algorithm to determine whether a pattern exists in at least some of the events of at least two of the sessions, are described in greater detail elsewhere herein, e.g., see the flowchart of FIG. 7B.

In some approaches, in response to a determination that a pattern does not exist in at least some of the events of at least two of the sessions, it may be determined that an implicit request for a new candidate feature is not present in the user data. In response to such a determination, other user data may be analyzed in some approaches. Alternatively, in response to such a determination, it may be concluded that a new candidate feature is not requested, and additional user data may be obtained and analyzed, e.g., at a later time, at a later date, in response to at least a predetermined number of new sessions occurring, etc. In contrast, in some approaches, it is determined that a pattern exists in at least some of the events of at least two of the sessions. For example, a pattern may be determined to exist in nodes of two or more sessions. In response to such a determination, events associated with the determined pattern may be determined to define the subset of the user data. For context, the subset of the user data may correspond to actions that are frequently performed by the user while interacting with the predetermined product. This is why nodes associated with these actions are determined to be present in a predetermined extent of the sessions, e.g., the pattern in the graphs. Accordingly, in order to relatively enhance aspects of the predetermined product with respect to the subset of the user data, method 300 includes determining, based on the subset of the user data, a potential new candidate feature for the predetermined product that satisfies the implicit request, e.g., see operation 308. In some approaches, determining the new candidate feature for the predetermined product that satisfies the implicit request may include applying a predetermined named entity recognition (NER) algorithm on the subset of the user data. The NER algorithm may be used to extract entities from given nodes, e.g., the nodes of the pattern. In some approaches, the new candidate features may be determined based on these entities. For example, a table may include features that may be incorporated into the predetermined product may be accessed in such a determination. The table may additionally include entities that are pre-associated with one or more of the features of the table. For example, assuming that cost related entities, purchase related entities and/or baking related entities are extracted using the NER algorithm, and assuming that one or more of such entities are pre-associated with a financial dashboard feature in the table, a new candidate feature for the predetermined product that satisfies the implicit request may include the financial dashboard feature. Such a financial dashboard feature may provide the user with a relatively improved experience while interacting with the predetermined product, e.g., a clearer picture and overview of financial activities.

In contrast to various approaches above which are based on user data that is based on user behavior, in some approaches, techniques for analyzing the user data may additionally and/or alternatively be based on user data that includes text-based data. In one or more of such approaches, analyzing the user data may include executing a predetermined natural language processing (NLP) algorithm on text of the text-based user data. In some approaches, the predetermined NLP algorithm may include a passive pattern detector. The passive pattern detector may be configured to review the text-based data and determine whether a pattern exists in the text-based data. For example, the passive pattern detector may be applied to a plurality of complaint reports and/or emails to determine whether any patterns exist in the complaint reports and/or emails. Such patterns may, in some approaches, include words that exist within predetermined range of frequencies within the text-based data. An upper bound of the predetermined range of frequencies may filter out words such as “a,” “the,” and “are,” which occur relatively frequently within the text-based data, but which are not necessarily related to the interaction with the predetermined product. In contrast, a lower bound of the predetermined range of frequencies may filter out words that appear relatively infrequently within the text-based data and thereby do not establish a pattern among the text-based data. Subsequent to applying the passive pattern detector to the text-based data, an output of the passive pattern detector may include words that exist with a predetermined frequency in predetermined number of the documents from which the text-based data is extracted. In some approaches, these words may be compared with a table that includes features that may be incorporated into the predetermined product. The features of the table may be pre-associated with words of the table. Accordingly, words of the output of the passive pattern detector may be matched with words of the table to determine a new candidate feature for the predetermined product that satisfies the implicit request.

In some approaches, text summarization may be applied to an output of the NLP algorithm to identify an issue that the user has experienced while using the predetermined product. Accordingly, in some approaches, an NLP processor that is configured to perform the predetermined NLP algorithm may include an issue detector, e.g., a predetermined algorithm. In one example, an issue summarization reported by the NLP processor may specify that a user is unable to view reserved instances (RIs) purchased and a utilization. In order to determine the new candidate feature for the predetermined product that satisfies the implicit request, method 300 may include executing a predetermined NER algorithm on the output of the NLP algorithm, where the new candidate feature addresses the identified issue. For example, in continuation of the example above in which it is determined that the user is unable to view the RIs purchased and the utilization, predetermined NER algorithm may be applied to extract components from the output of the NLP algorithm to determine a remedy for the detected issue. For context, the components may be features that remedy the detected issue, e.g., a cost dashboard, a discount plan dashboard, an insights dashboard, an RIs dashboard, etc.

Sentiment analysis may additionally and/or alternatively be incorporated into the NLP processing performed by the NLP processor on the user data. For example, a predetermined sentiment analysis algorithm may be configured to search for and potentially identify predetermined keywords within the user data. These keywords are preferably based on emotions that the user may experience during the user's behavior with respect to the predetermined product. For example, syntax such as an exclamation point may be identified by the sentiment analysis algorithm and the user may be determined to have an angry sentiment during the user's behavior with respect to the predetermined product. Text associated with this sentiment, e.g., within the same paragraph, within the same sentence within a predetermined number of words, etc., may be specifically considered for determining the new candidate feature. For example, the predetermined NLP algorithm and/or the sentiment analysis algorithm may identify a statement within a complaint email of the user that specifies “I forgot which RIs I purchased!” The terms “forgot” and/or “RI” may be determined to be associated with the sentiment syntax “!”, and it may be determined that a cost dashboard is a feature that the user would benefit from while interacting with the predetermined product. The sentiment of the user may additionally and/or alternatively be used to determine a severity of the new feature. For example, in the previous example, it may be determined that the user is angry, and therefore a size of the dashboard devoted to RIs may be relatively larger than other aspects of the dashboard. The severity may also be indicated in an indication output to a predetermined device associated with development and/or management of the predetermined product, e.g., see operation 310, to stress the importance of and time sensitive nature of the proposed new feature. This may also help retain customers. In another examples, it may be determined that the sentiment of the user is neutral in response to a determination that predetermined syntax and/or words are and/or are not present in the user data, e.g., “no rush.” In yet another example, it may be determined that the sentiment of the user is relaxed in response to a determination that predetermined syntax and/or words are and/or are not present in the user data, e.g., “it is not important to me.”

Operation 310 includes outputting an indication and/or identification of the determined potential new candidate feature to a device associated with development of the predetermined product. Such a device may manage the predetermined product based on being responsible for incorporating candidate features into the predetermined product. More specifically, in some approaches, the device associated with development of the predetermined product may be, e.g., a computer of someone on a development team that manages the predetermined product, a device that stores development information about the predetermined product, a computer that is used to update the predetermined product, etc. For context, in some preferred approaches, the indication and/or identification is configured to relay the determined new candidate feature to the device associated with development of the predetermined product. For example, the indication and/or identification may include, e.g., a description of the determined new candidate feature, a name of the determined new candidate feature such as where the feature or a similar feature already has been developed but not yet deployed on the predetermined product, a class to which the determined feature belongs, etc. In some approaches, the determined new feature indicated in the output may be a suggestion, and the output may additionally include an instruction to confirm that the determined new feature would satisfy the implicit request in the event that the determined new feature is incorporated on the predetermined product. The output may additionally and/or alternatively include other information, e.g., a summary of the findings of the analysis, a sentiment of the user associated with the implicit request, a mapping of the analysis performed on the user data, the user data, etc. In some approaches, the indication and/or identification of the determined potential new candidate feature may be output to a device associated with development of a subset of the the predetermined product. For example, in some implementations, a plurality of different developer groups may each be responsible for managing, developing and implementing a different type of feature on the predetermined product. Accordingly, in some approaches, method 300 may include determining a developer group and an associated device that the new candidate feature is to be developed and implemented by, and outputting the indication and/or identification to the associated device.

In some approaches, it may additionally and/or alternatively be determined that the user explicitly makes a request for a new candidate feature. For example, a user requested feature may be determined from the text based analysis in which the customer explicitly asks a product management team about new features for the predetermined product. Accordingly, method 300 may include enabling an option to a customer to send such requests using any one or more communication channels, e.g., a chat window, an email, an answer to a query, etc.

It should also be noted that the implicit request may be determined using shadow information and technology (IT) in some approaches. For example, the shadow IT may capture an actual requirement from end users and partners that if incorporated into the predetermined product, would be useful to the user. In order to capture such information, in some approaches, the shadow IT resources may not be aware of such actual requirements from customers and/or partners due to a lack of knowledge. Accordingly, such requirements may be captured via implied requests by analyzing user data, e.g., which may include data captured by the shadow IT resources, using various techniques described herein.

Numerous benefits are enabled as a result of utilizing various of the novel techniques described in embodiments and approaches described herein. For example, these techniques enable a scalable and cost-effective solution for offerings with a relatively large and diverse set of customers where unit economics is key. The potential for a relative increase in revenue is also enabled as a result of utilizing the techniques described herein. This is because such techniques enable upsell and/or cross-sell opportunities of solutions for new use cases. Usage and/or consumption are also driven in a consumption-based pricing model as a result of utilizing such techniques. Relatively efficient and streamlined requirement gathering and processing is furthermore enabled particularly for product owners, which thereby makes these techniques a data driven solution to issues experienced in environments that use the conventional techniques described elsewhere herein. Relatively improved adoption and consumption is also enabled by enhancing user experience and “stickiness” by delivering proactive new features in addition to maintaining a targeted awareness of existing features that would otherwise be unknown and/or unfamiliar to the end-user. Data loss and bias/assumptions may also be removed as a result of the operative communication flow described herein. This mitigates conventional issues between end users to engineering that is otherwise experienced using conventional techniques.

Benefits enabled as a result of utilizing various of the novel techniques described in embodiments and approaches described herein furthermore include relative increases in user productivity. This is because these techniques proactively determine new candidate features that are useful to users, without the user making an explicit request for such features. Instead, an implicit request is identified from user data, and a new candidate feature is identified in order to improve the efficiency of the user while behaving, e.g., performing actions, with respect to the predetermined product. Accordingly, a relative amount of computer processing that is performed on a computer device that hosts the product and/or an application thereof is also reduced. This is because interaction with the predetermined product is streamlined by features determined to be most relevant to prior user data being determined and incorporated into the predetermined product. It should be noted that analyzing user data for determining a subset of the user data that constitutes an implicit request for a new candidate feature for the predetermined product, and determining, based on the subset of the user data, a new candidate feature for the predetermined product that satisfies the implicit request; has heretofore not been considered in conventional techniques. Accordingly, the inventive discoveries disclosed herein that detail an adaptive system and methods to discover new product features based on user behavior and infrastructure proceed contrary to conventional wisdom.

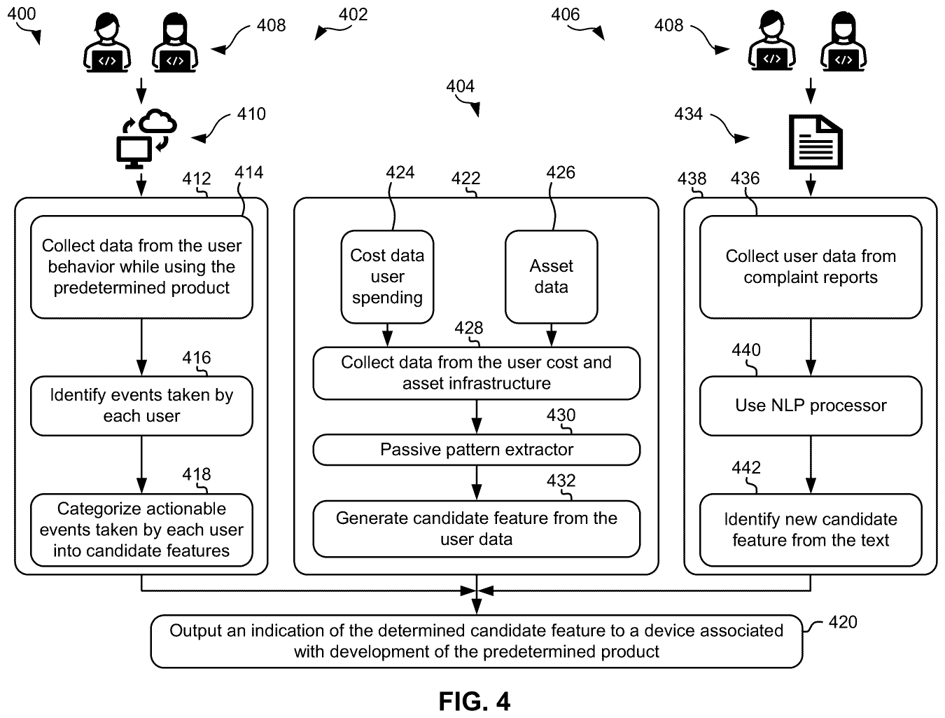

Now referring to FIG. 4, a flowchart of a method 400 is shown according to one embodiment. The method 400 may be performed in accordance with the present invention in any of the environments depicted in FIGS. 1-8, among others, in various embodiments. Of course, more or fewer operations than those specifically described in FIG. 4 may be included in method 400, as would be understood by one of skill in the art upon reading the present descriptions.

Each of the steps of the method 400 may be performed by any suitable component of the operating environment. For example, in various embodiments, the method 400 may be partially or entirely performed by a computer, or some other device having one or more processors therein. The processor, e.g., processing circuit(s), chip(s), and/or module(s) implemented in hardware and/or software, and preferably having at least one hardware component may be utilized in any device to perform one or more steps of the method 400. Illustrative processors include, but are not limited to, a central processing unit (CPU), an application specific integrated circuit (ASIC), a field programmable gate array (FPGA), etc., combinations thereof, or any other suitable computing device known in the art.

It may be prefaced that method 400 depicts a relatively high level overview of various operations of the flowchart of method 300. More specifically, the flowchart of method 400 includes a plurality of paths that may be followed in order to determine a new candidate feature for predetermined product, where the new candidate feature satisfies an implicit request of a subset of analyzed user data. For example, a first column 402 of the flowchart of method 400 may be performed based on user data that includes user behavior while using the predetermined product. A second column 404 of the flowchart of method 400 may be performed based on cost data and asset data of an infrastructure. Customer infrastructure data is one of the “hidden” sources that may be used to identify potential hidden features, e.g., implicitly needed based on the user's behavior. For instance, for a customer that increases their RI purchase every month doesn't have a view to visualize utilization thereof, there is a potential implicit need of the customer for a RI dashboard to view such utilization. Finally, a third column 406 of the flowchart of method 400 may be performed based on user data that is based on text-based data, e.g., such as complaint reports, which may be associated with the user using the predetermined product, in some approaches. It should be noted that the flowchart of FIG. 4 is not intended to limit the descriptions herein, and any of the columns may be performed independently and/or concurrently, depending on the approach.

With reference now to the first column 402 of method 400, users 408 may interact with devices that are configured to interact with a predetermined product 410 that includes at least some features. Monitoring may be performed, e.g., using techniques described elsewhere herein, on the behavior of the users 408 subsequent to gaining permission from the users. In a subprocess 412 of the first column 402, user data associated with a user's behavior is collected with respect to the predetermined product 410, e.g., see operation 414. Operation 416 includes identifying events taken by each of the users 408, e.g., using the comparative techniques described elsewhere herein. Operation 418 includes categorizing the actionable events taken by each of the users 408 into new candidate features. This categorization may include applying a predetermined NER algorithm on a subset of the user data, e.g., the user data associated with a detected pattern based on each of the users 408 taking the events. An indication of the determined candidate feature may be output to a device associated with development of the predetermined product, e.g., see operation 420.

With reference now to a subprocess 422 of the second column 404 of method 400, user data, e.g., cost data associated with user spending 424 and asset data 426 of an asset infrastructure of the user is collected, e.g., see operation 428. The user data may be associated with the user's behavior with respect to the predetermined product. Operation 430 includes applying a passive pattern detector to the user data using techniques described elsewhere herein. New candidate features may be generated from the user data, e.g., see operation 432, and an indication of the determined candidate feature may be output to the device associated with development of the predetermined product, e.g., see operation 420.

With reference now to the third column 406 of method 400, the users 408 may interact with devices that are configured to interact with the predetermined product 410 that includes at least some features. Monitoring may be performed, e.g., using techniques described elsewhere herein, on the behavior of the users 408 subsequent to gaining permission from the users. Text-based user data, e.g., see complaint report 434, may be collected, e.g., see operation 436 of subprocess 438. In operation 440 the user data is analyzed by executing a predetermined NLP algorithm of an NLP processor on the user data. In some approaches, text summarization may be applied to an output of the NLP algorithm to identify an issue that the user has experienced while using the predetermined product. In operation 442 a candidate feature may be identified from the text, e.g., the text summarization, and an indication of the determined candidate feature may be output to the device associated with development of the predetermined product, e.g., see operation 420.

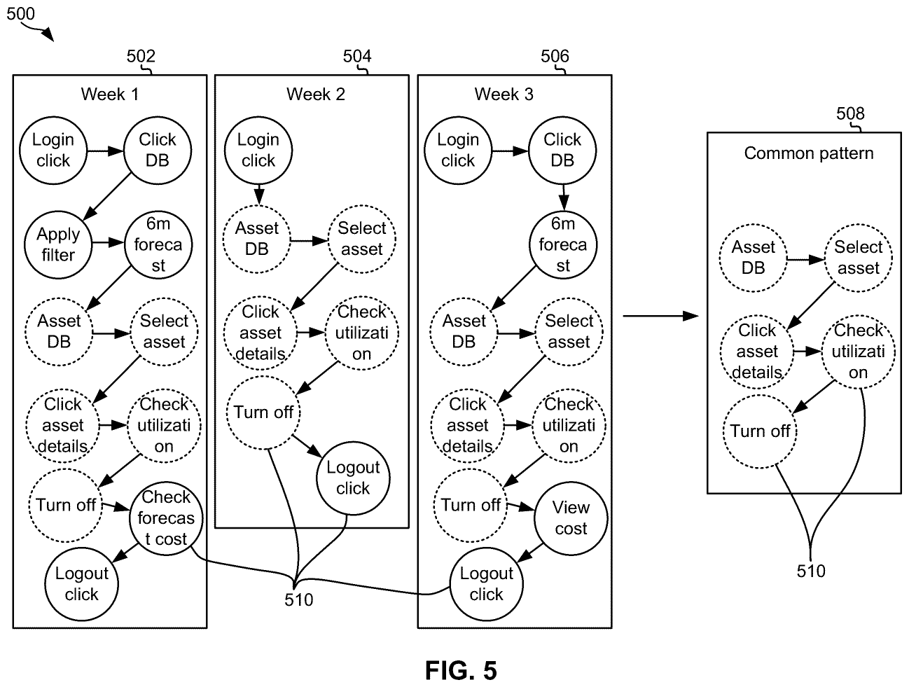

FIG. 5 depicts a comparison 500, in accordance with one embodiment. As an option, the present comparison 500 may be implemented in conjunction with features from any other embodiment listed herein, such as those described with reference to the other FIGS. Of course, however, such comparison 500 and others presented herein may be used in various applications and/or in permutations which may or may not be specifically described in the illustrative embodiments listed herein. Further, the comparison 500 presented herein may be used in any desired environment.

The comparison 500 includes a plurality of graphs, e.g., see graph 502, 504 and 506 that are each associated with a different session, e.g., see week 1, week 2 and week 3, in which a user interacts with a predetermined product that has features. Events that occur during the interaction sessions are determined and characterized as nodes 510 in the graphs. For example, a login click is detected, a six month forecast is reviewed on the predetermined product, a utilization is checked, a cost forecast is checked, a cost is viewed, etc. Arrows connecting the nodes 510 note a progression in which the events were performed during the interaction with the predetermined product.

A predetermined pattern detection algorithm is applied on the nodes 510 associated with the events to determine whether a pattern exists in at least some of the events of at least two of the sessions. A common pattern is identified in a plurality of the nodes in each of the sessions, e.g., see nodes with a dashed line. The common pattern is further illustrated in box 508, e.g., see common pattern. The events associated with the determined pattern may be determined to define the subset of the user data, and a new candidate feature for the predetermined product that satisfies an implicit request associated with the subset of the user data may be determined.

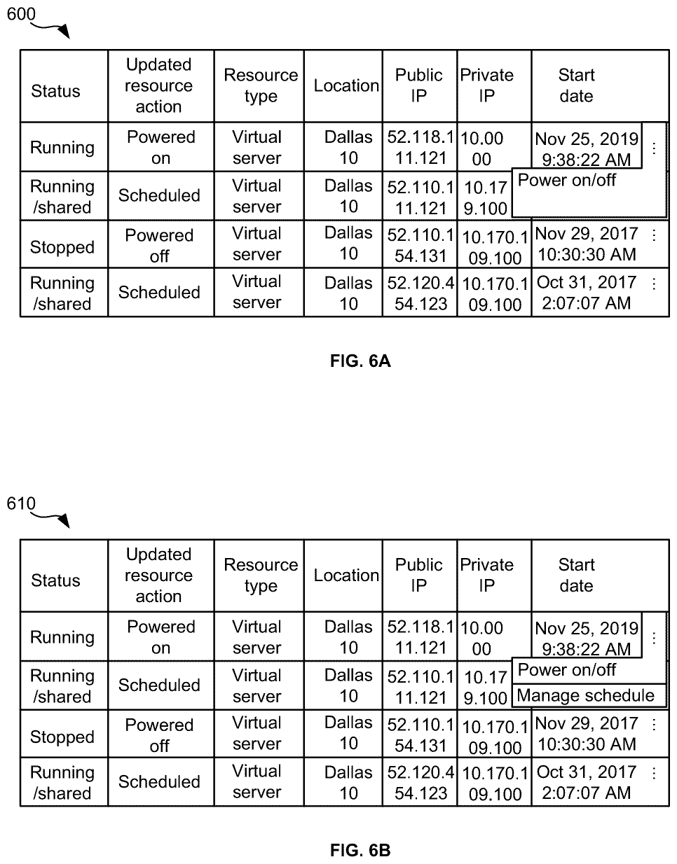

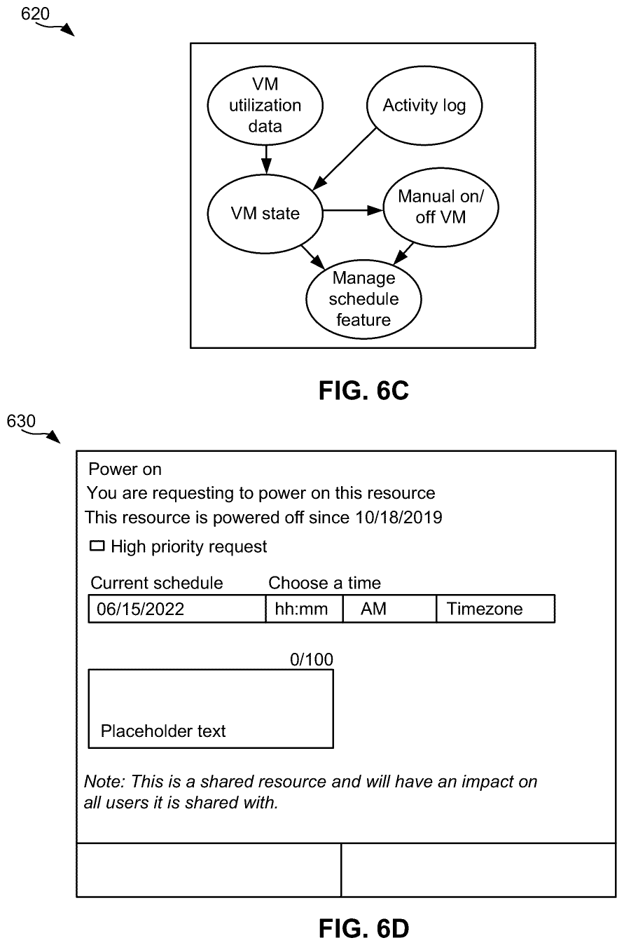

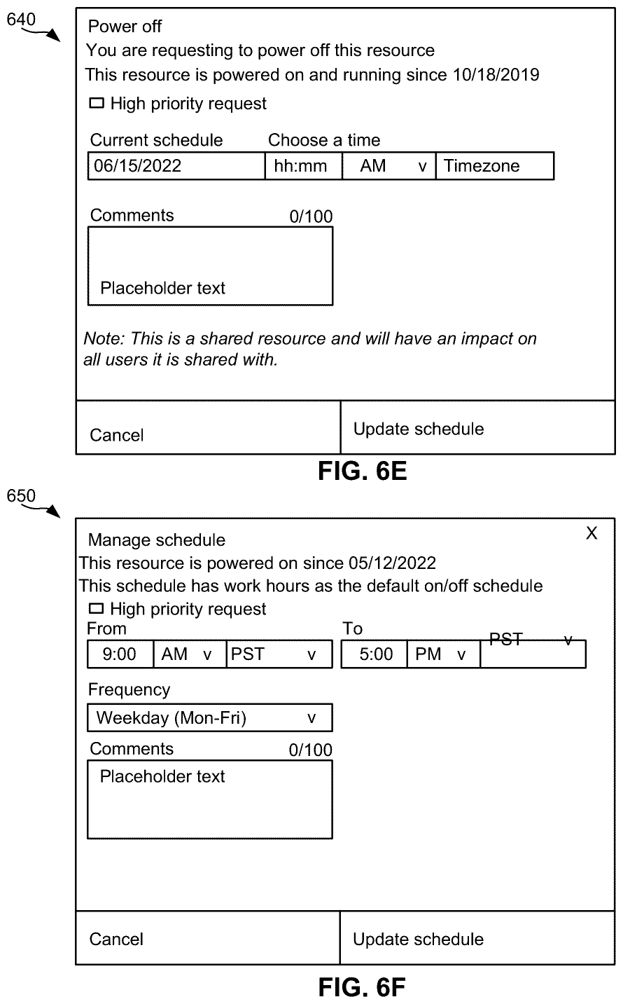

FIGS. 6A-6F depict representations 600, 610, 620, 630, 640, and 650 for determining and implementing a new candidate feature for a predetermined product based on a determined implicit request, in accordance with several embodiments. As an option, the present representations 600, 610, 620, 630, 640, and 650 may be implemented in conjunction with features from any other embodiment listed herein, such as those described with reference to the other FIGS. Of course, however, such representations 600, 610, 620, 630, 640, and 650 and others presented herein may be used in various applications and/or in permutations which may or may not be specifically described in the illustrative embodiments listed herein. Further, the representations 600, 610, 620, 630, 640, and 650 presented herein may be used in any desired environment.

Referring first to FIG. 6A, representation 600 is a dashboard feature of a predetermined product, e.g., a virtual machine (VM). For example, the dashboard includes a plurality of potential statuses of the predetermined product. The dashboard furthermore includes a selectable feature that, in response to being selected, causes a device associated with the predetermined product to be powered on and off, e.g., see power on/off.

Referring now to FIG. 6B, representation 610 includes the dashboard of representation 600, but the predetermined product has been caused, e.g., instructed, to be updated to include a new candidate feature, e.g., see manage schedule. Techniques for determining that a subset of user data constitutes an implicit request for such a new candidate feature for the predetermined product is detailed in FIG. 6C, according to one approach.

Representation 620 includes various types of user data that may be analyzed to determine implicit request and the new candidate feature. For example, VM utilization data and data of an activity log are associated with the predetermined product changing between different states, e.g., see VM states, during a user's interaction with the predetermined product. From this data it may be determined that the user performs a manual task in each interaction session with the predetermined product in order to power on and power off the VM, e.g., see manual on/off VM. Accordingly, it may be determined, e.g., from the user data, that at least a subset of the user data, e.g., the activity log and/or the VM utilization data, constitutes an implicit request, e.g., functional need unknown to the user, for a new candidate feature for the predetermined product that includes a manage schedule feature.

Referring now to FIG. 6D, the representation 630 further illustrates the power on feature of the predetermined product, e.g., previously depicted in FIGS. 6A-6B.

Referring now to FIG. 6E, the representation 640 further illustrates the power off feature of the predetermined product, e.g., previously depicted in FIGS. 6A-6B.

Referring now to FIG. 6F, the representation 650 further illustrates the manage schedule feature of the predetermined product, e.g., previously depicted in FIG. 6B. It may be noted that the new candidate feature for managing the user's schedule as shown in representation 650 may be modeled off of various features of the representations 630 and 640.

Now referring to FIG. 7A, a flowchart of a method 700 is shown according to one embodiment. The method 700 may be performed in accordance with the present invention in any of the environments depicted in FIGS. 1-8, among others, in various embodiments. Of course, more or fewer operations than those specifically described in FIG. 7 may be included in method 700, as would be understood by one of skill in the art upon reading the present descriptions.

Each of the steps of the method 700 may be performed by any suitable component of the operating environment. For example, in various embodiments, the method 700 may be partially or entirely performed by a computer, or some other device having one or more processors therein. The processor, e.g., processing circuit(s), chip(s), and/or module(s) implemented in hardware and/or software, and preferably having at least one hardware component may be utilized in any device to perform one or more steps of the method 700. Illustrative processors include, but are not limited to, a central processing unit (CPU), an application specific integrated circuit (ASIC), a field programmable gate array (FPGA), etc., combinations thereof, or any other suitable computing device known in the art.

Operation 702 includes collecting user data associated with a user's behavior with respect to a predetermined product over a plurality of sessions, e.g., see Session1, Session2, Session3, Session4, Session n−1, and Session n.

The user data is analyzed for determining a subset of the user data that constitutes an implicit request for a new candidate feature for the predetermined product. In some approaches, a combined pattern detection algorithm, which may be an isomorphic subgraph detection algorithm, is used to analyze the data, e.g., see operation 704. Looking to FIG. 7B, exemplary sub-operations of using the combined pattern detection algorithm are illustrated in accordance with one embodiment, one or more of which may be used to perform operation 704 of FIG. 7A. However, it should be noted that the sub-operations of FIG. 7B are illustrated in accordance with one embodiment which is in no way intended to limit the invention.

Referring now to FIG. 7B, sub-operation 730 includes generating a sequence of graphs, where each graph corresponds to user data obtained from a different session. Techniques for generating a graph described elsewhere herein may be used to generate the sequence of graphs, e.g., creating nodes for actions that occurred in the sessions.

A first graph of the sequence of graphs is traversed through, e.g., see sub-operation 732. Note that additional nodes of the graphs of the sequence of graphs may be traversed through, e.g., see sub-operation 736, and therefore at least a second graph may be created. As a result of the traversal, nodes corresponding to actions associated with use of the predetermined product are identified, and a map with edges and nodes from the traversed graphs may be created, e.g., see sub-operation 734. In sub-operation 738. It may be determined whether edges and node pairs of the first graph are present in the second graph, e.g., whether a pattern exists in each of the plurality of graphs. In response to a determination that edges and node pairs of the first graph are not present in the second graph, e.g., as illustrated by the “No” logical path of sub-operation 738, the sub-process optionally ends, e.g., see “End”, and it may be determined that a pattern does not exist. In contrast, in response to a determination that edges and node pairs of the first graph are present in the second graph, e.g., as illustrated by the “Yes” logical path of sub-operation 738, sub-operation 740 is optionally performed. These edge and node pairs may be added to an intersection graph, e.g., see sub-operation 740. The intersection graph may be used to represent patterns in the user data. Further user data of additional segments may be considered. For example, sub-operation 742 includes taking the intersection graph and checking for an existence of edges and nodes in subsequent graphs. Where data of such additional graphs does not match the pattern, an intersection will not exist. Accordingly, an entry may be removed from the intersection graph if the entry is a pair that is not available, e.g., see sub-operation 744. As a result, this user data will not be included in the subset of user data that constitutes the implicit request. In contrast, user data that is in the intersection graph may define the subset of user data that constitutes the implicit request.

An output of using the combined pattern detection algorithm, e.g., see FIG. 7B, preferably includes a common pattern that exists across the graphs.

Method 700 may additionally and/or alternatively include determining, based on the subset of the user data, a new candidate feature for the predetermined product that satisfies the implicit request. In some approaches, determining the new candidate feature for the predetermined product that satisfies the implicit request includes applying a predetermined NER algorithm on the subset of the user data, e.g., see operation 708. Block 706 includes a plurality of nodes 710, 712, 714, 716, 718, 720 and 722 that represents the subset of user data. For example, the nodes may represent user data associated with behavior taken with respect to the predetermined product, e.g., clicking a cost dashboard, computing an apply filter, clicking a forecast button, clicking an asset dashboard, making a VM selection, clicking a date button, clicking a schedule button, etc.

Operation 724 includes outputting the determined new candidate features to a developer device.

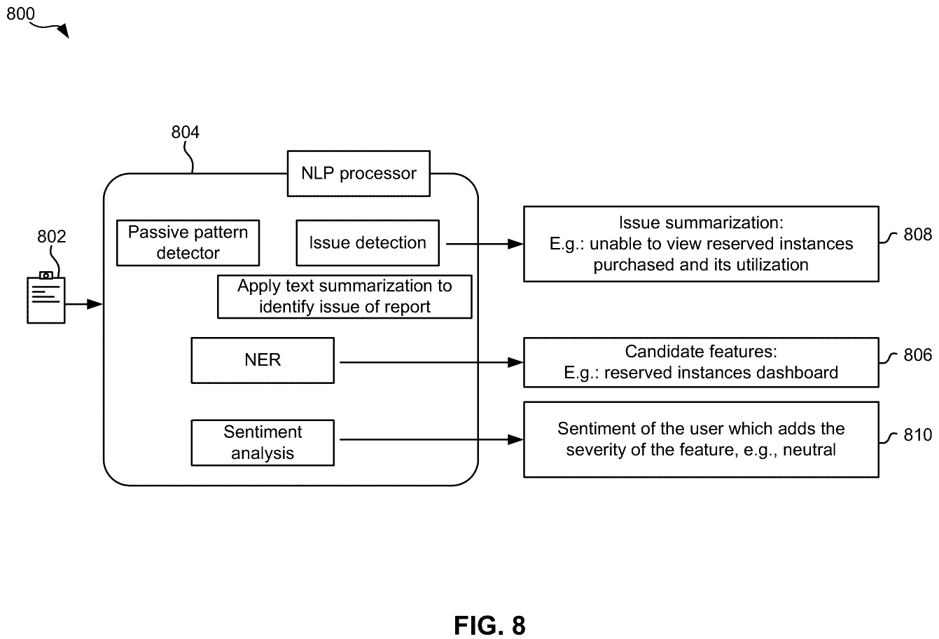

Now referring to FIG. 8, a flowchart of a method 800 is shown according to one embodiment. The method 800 may be performed in accordance with the present invention in any of the environments depicted in FIGS. 1-8, among others, in various embodiments. Of course, more or fewer operations than those specifically described in FIG. 8 may be included in method 800, as would be understood by one of skill in the art upon reading the present descriptions.

Each of the steps of the method 800 may be performed by any suitable component of the operating environment. For example, in various embodiments, the method 800 may be partially or entirely performed by a computer having a processor, or some other device having one or more processors therein. The processor, e.g., processing circuit(s), chip(s), and/or module(s) implemented in hardware and/or software, and preferably having at least one hardware component may be utilized in any device to perform one or more steps of the method 800. Illustrative processors include, but are not limited to, a central processing unit (CPU), an application specific integrated circuit (ASIC), a field programmable gate array (FPGA), etc., combinations thereof, or any other suitable computing device known in the art.

Operation 802 includes collecting user data associated with a user's behavior with respect to a predetermined product. The user data is analyzed for determining a subset of the user data that constitutes an implicit request for a new candidate feature for the predetermined product, e.g., see operation 804. In some approaches, an NLP processor may be used to perform such analysis on the user data. Similar to as described elsewhere herein, e.g., see operation 308 of method 300, the NLP processor may utilize NER, which may be used to determine candidate features such a dashboard for RIs, e.g., see 806. A passive pattern detector may additionally and/or alternatively be used to identify the patterns in the user data. In some approaches, the NLP processor may utilize issue detection techniques described elsewhere herein, e.g., see operation 308 of method 300, to determine a summarization of an issue that the user is experiencing, e.g., the user is unable to view RI purchased and a utilization, e.g., see 808. The NLP processor may additionally and/or alternatively utilize sentiment analysis to determine a sentiment of the user which may add to a severity of the feature, e.g., see 810.

It will be clear that the various features of the foregoing systems and/or methodologies may be combined in any way, creating a plurality of combinations from the descriptions presented above.

It will be further appreciated that embodiments of the present invention may be provided in the form of a service deployed on behalf of a customer to offer service on demand.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
collecting user data associated with a user's behavior with respect to a predetermined product;
analyzing the user data for determining a subset of the user data that constitutes an implicit request for a new candidate feature for the predetermined product;
determining, based on the subset of the user data, a new candidate feature for the predetermined product that satisfies the implicit request; and
outputting an indication of the determined new candidate feature to a device associated with development of the predetermined product.

2. The computer-implemented method of claim 1, wherein the user's behavior includes use of a first device to interact with the predetermined product, wherein collecting the user data associated with the user's behavior with respect to the predetermined product includes monitoring the user's behavior with respect to the predetermined product.

3. The computer-implemented method of claim 2, wherein the user data is collected from a plurality of sessions in which the user uses the first device to interact with the predetermined product, wherein analyzing the user data for determining the subset of the user data includes performing process for each of the sessions, the process including: identifying, for each session, events taken by the user during the session, and applying a predetermined pattern detection algorithm on the events of the sessions to determine whether a pattern exists in at least some of the events of at least two of the sessions.

4. The computer-implemented method of claim 3, wherein the predetermined pattern detection algorithm is applied to a graph that includes nodes each associated with a different one of the events.

5. The computer-implemented method of claim 3, wherein it is determined that a pattern exists in at least some of the events of at least two of the sessions, wherein the events associated with the determined pattern define the subset of the user data, wherein determining, based on the subset of the user data, new candidate feature for the predetermined product that satisfies the implicit request includes applying a predetermined named entity recognition (NER) algorithm on the subset of the user data.

6. The computer-implemented method of claim 1, wherein the user data includes text-based data.

7. The computer-implemented method of claim 6, wherein analyzing the user data includes executing a predetermined natural language processing (NLP) algorithm on the user data, and applying text summarization to an output of the NLP algorithm to identify an issue that the user has experienced while using the predetermined product.

8. The computer-implemented method of claim 7, wherein determining, based on the subset of the user data, the new candidate feature for the predetermined product that satisfies the implicit request includes executing a predetermined named entity recognition (NER) algorithm on the output of the NLP algorithm, wherein the new candidate feature addresses the identified issue.

9. The computer-implemented method of claim 6, wherein the user data is collected from a group consisting of: the user's reports, the user's messages, cost data, and asset data.

10. A computer program product, the computer program product comprising a computer readable storage medium having program instructions embodied therewith, the program instructions executable by a computer to cause the computer to:
collect, by the computer, user data associated with a user's behavior with respect to a predetermined product;
analyze, by the computer, the user data for determining a subset of the user data that constitutes an implicit request for a new candidate feature for the predetermined product;
determine, by the computer, based on the subset of the user data, a new candidate feature for the predetermined product that satisfies the implicit request; and
output, by the computer, an indication of the determined new candidate feature to a device associated with development of the predetermined product.

11. The computer program product of claim 10, wherein the user's behavior includes use of a first device to interact with the predetermined product, wherein collecting the user data associated with the user's behavior with respect to the predetermined product includes monitoring the user's behavior with respect to the predetermined product.

12. The computer program product of claim 11, wherein the user data is collected from a plurality of sessions in which the user uses the first device to interact with the predetermined product, wherein analyzing the user data for determining the subset of the user data includes performing process for each of the sessions, the process including: identifying, for each session, events taken by the user during the session, and applying a predetermined pattern detection algorithm on the events of the sessions to determine whether a pattern exists in at least some of the events of at least two of the sessions.

13. The computer program product of claim 12, wherein the predetermined pattern detection algorithm is applied to a graph that includes nodes each associated with a different one of the events.

14. The computer program product of claim 12, wherein it is determined that a pattern exists in at least some of the events of at least two of the sessions, wherein the events associated with the determined pattern define the subset of the user data, wherein determining, based on the subset of the user data, new candidate feature for the predetermined product that satisfies the implicit request includes applying a predetermined named entity recognition (NER) algorithm on the subset of the user data.

15. The computer program product of claim 10, wherein the user data includes text-based data.

16. The computer program product of claim 15, wherein analyzing the user data includes executing a predetermined natural language processing (NLP) algorithm on the user data, and applying text summarization to an output of the NLP algorithm to identify an issue that the user has experienced while using the predetermined product.

17. The computer program product of claim 16, wherein determining, based on the subset of the user data, the new candidate feature for the predetermined product that satisfies the implicit request includes executing a predetermined named entity recognition (NER) algorithm on the output of the NLP algorithm, wherein the new candidate feature addresses the identified issue.

18. The computer program product of claim 15, wherein the user data is collected from a group consisting of: the user's reports, the user's messages, cost data, and asset data.

19. A system, comprising:
a hardware processor; and
logic integrated with the processor, executable by the processor, or integrated with and executable by the processor, the logic being configured to:
collect user data associated with a user's behavior with respect to a predetermined product;
determine a new candidate feature for the predetermined product that satisfies an implicit request for a new candidate feature for the predetermined product, wherein the implicit request is based on a subset of the user data; and
output an indication of the determined new candidate feature to a device associated with development of the predetermined product.

20. The system of claim 19, wherein the user's behavior includes use of a first device to interact with the predetermined product, wherein collecting the user data associated with the user's behavior with respect to the predetermined product includes monitoring the user's behavior with respect to the predetermined product, and the logic being configured to: analyze the user data for determining the subset of the user data that constitutes the implicit request for a new candidate feature for the predetermined product.
